(19) United States
(12) Patent Application Publication
(10) Pub. No.: US 2016/0021189 A1
(43) Pub. Date: Jan. 21, 2016

(54) AUTOMATIC PUSHING OF M2M SIGNAL PROCESSING TO NETWORK SENSOR EDGE

(71) Applicant: Cluster Wireless LLC, San Diego, CA (US)

(72) Inventors: Prem Jothipragasam Kumar, San Diego, CA (US); Thomas O'Neill, La Jolla, CA (US); Robbin David Hughes, Plano, TX (US); Ramesh Rajasekaran, Chennai (IN)

(73) Assignee: Cluster Wireless LLC

(21) Appl. No.: 14/334,601

(22) Filed: Jul. 17, 2014

(51) Int. Cl. H04L 29/08

(52) U.S. Cl. CPC H04L 67/12; H04L 67/10; H04L 67/26

(57) ABSTRACT

Embodiments herein generally relates to a system and method to automatically offloading a signal processing operation from a back-end processing server to a node controlled using a central controller in a Machine-to-Machine (M2M) network. Further, the method includes identifying a raw data stream in the node. Further, the method includes receiving a parameter associated with the node in the M2M network. Further, the method includes determining the capability of the node based on a plurality of rules. Further, the method includes processing the raw data stream at the corresponding node based on the identified capability. The node can further include a signal processing agent received from the central controller to process the raw data stream.

### TECHNICAL FIELD

The embodiments herein relate to Machine-to-Machine (M2M) network system management. More particularly, for automatically pushing of signal processing operations from a back-end processing server to a node or sensor edge in the M2M network.

### BACKGROUND

Modern machine to machine (M2M) communications has expanded beyond a one-to-one connection and changed into a system of M2M networks. The M2M networks generally implement a dynamic topology in which devices such as sensors are associated and disassociated with each other. The roles and responsibilities of each such senor may change over time and thus there remain unique challenges for processing raw M2M sensors data in the M2M networks.

Different systems and methods are proposed to efficiently process the raw sensors data in the M2M networks. The conventional systems use a back-end processing server to process the raw data acquired or generated at each individual sensor in the M2M network. The back-end processing server includes a web application using signal processing configurations to process the raw sensor data in the M2M network. The sensor configuration is performed from the back-end processing server which also handles the transport of the raw M2M sensor data through the network from the sensor to the back-end processing server. Further, signal processing such as ranging and statistical analysis, is typically performed in the back-end processing server, which may significantly increases the overall network usage cost as the data need to be transported up using various links from the sensors to the back-end processing server. If the signal processing is done in the sensor itself then it is done using a static pre-loaded processing capability in the sensor. Thus, there remains a need of robust and simple system and method for automatically offloading the signal processing operations from the back-end processing server down through the M2M network to the sensor endpoint.

### BRIEF DESCRIPTION OF THE FIGURES

The embodiments herein will be better understood from the following detailed description with reference to the drawings, in which:

FIG. 1 illustrates, among other things, a high level overview of a Machine-to-Machine (M2M) network management system, according to embodiments described herein;

FIG. 2 expands features and functions of a node as described in the FIG. 1, according to embodiments described herein;

FIG. 3 illustrates functions of a central controller as described in the FIG. 1, according to embodiments as disclosed herein;

FIG. 4 is a flowchart illustrating a method for automatically offloading a signal processing operation from a back-end processing server down through the M2M network to the nodes endpoint, according to embodiments described herein;

FIG. 5 illustrates exemplary rules for determining the capability of a node to process a raw data stream, according to embodiments as disclosed herein;

FIG. 6 is a flowchart illustrating a method for managing and updating the signal processing agents at each node in the M2M network, according to embodiments disclosed herein; and

FIG. 7 illustration an example scenario of managing and updating the signal processing agents at each node in the M2M network, according to embodiments described herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein disclose a method and system for automatically offloading one or more signal processing operations from a back-end processing server down through a machine to machine (M2M) network to nodes endpoint. A central controller can be configured to receive one or more parameters associated with the nodes in the M2M network. The central controller can include one or more rules to analyze the parameters to determine a capability of each node in the M2M network. Based on the capability of each node, the central controller can be configured to decide whether to process raw data stream at the node itself. At each node, a signal processing agent can be automatically downloaded and installed to process the raw sensor data streams at the node end itself. Unlike conventional systems, instead of transporting and processing the raw data steams at the back-end processing server, the proposed system and method can be used to process the raw data stream at the node end itself. A better end-to-end utilization of the M2M network resources and cost can be achieved as the signal processing is moved down to the node edge where the raw data streams is originating from, given there is enough processing capability in the node to process the raw data stream. The offloading of the signal processing operations from the back-end processing server down through the M2M network to the nodes endpoint compress down the amount of data points being transported up the links from the nodes to the back-end processing server, which significantly decreases the overall system cost.

The proposed system and method is simple, reliable, and robust for automatically offloading the signal processing agents from the back-end processing server to the node endpoints in the M2M network applications. The system and method can be used to evaluate and synchronize signal processing agents and automatically download, install, and update/upgrade signal processing agents to process the raw data stream of the node in the M2M network. Error-free, fast, synchronous, and inexpensive updates/upgrades can be performed for each node in the M2M networks. Further, the system and method can be used to increase performance, availability of resources, and improve efficiency of network applications management with significantly less cost and time. Unlike the conventional systems, the raw data stream generated in the node can be processed at the node itself by receiving the signal processing operations from the central controller; thereby, providing better end-to-end utilization of M2M network resources and cost, because signal processing at the node can compress down the amount of data points being transported from the nodes to the back-end processing server. Furthermore, the proposed system and method can be implemented using existing components and may not require extensive setup or instrumentation.

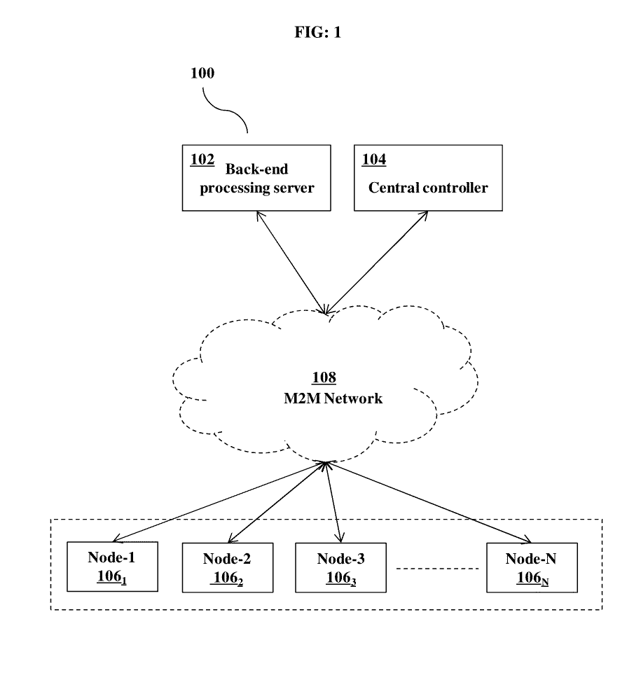

Referring now to the drawings, and more particularly to FIGS. 1 through 7, where similar reference characters denote corresponding features consistently throughout the figures, there are shown embodiments.

FIG. 1 illustrates, among other things, a high level overview of a Machine-to-Machine (M2M) network management system 100, according to embodiments described herein. The system 100 can provide a complete solution including a back-end processing server 102 (also referred as M2M server 102), central controller 104, plurality of nodes 106_{1-N} (hereafter referred as nodes 106) and a M2M network 108. The nodes 106 described herein can include for example, but not limited to, M2M devices, M2M sensors, and various other networks sources (not shown) such as routers, hubs, collectors, sensors, meters, storage devices, and the like. In an embodiment, the M2M network 108 described herein can include for example, but not limited to, wireless network, wire line network, cellular network, personal network, private network, public network such as the Internet, local area network (LAN), wide area network (WAN), metropolitan area network (MAN), global system for mobile communications (GSM) network, or a combination thereof.

In an embodiment, the back-end processing server 102 can be configured to store one or more signal processing agents required by the node 106 to process a raw data stream generated in the node 106 in the M2M network 108. Further, the server 102 can be configured to include or coupled to one or more databases describing current versions of the signal processing agents in the M2M network 108.

In an embodiment, the central controller 104 can be configured to collect the information about one or more parameters associated with each node 106 in the M2M network 108. The parameters described herein can include for example, but not limited to a, node availability, node characteristics, services offered by the node, service availability, service characteristics, service quality, processing power, battery condition, communication channel quality, profile data, user preferences, usage data, range, speed, bandwidth, cost, workload, security data, and congestion among the nodes 106 in the M2M network 108. The central controller 104 can be configured to use network analysis tools to analyze the collected parameters to determine the capability of the nodes 106 and provide the appropriate signal processing agents to process the raw data streams generated at the node 106 in the M2M network 108.

Further, the central controller 104 can be configured to generate the signal processing agents to the raw data stream associated with the node 106 based on the received parameters of the node 106 in the M2M network 108. In conventional systems, the raw data stream generated at the node 106 is sent to the central controller 104 to process the data stream using the signal processing operations present in the controller 104. Unlike conventional systems, instead of transporting and processing the raw data steams at the back-end processing server, the proposed system and method can be used to process the raw data stream at the node end itself. A better end-to-end utilization of the M2M network resources and cost can be achieved as the signal processing is moved down to the node edge where the raw data streams is originating from, given there is enough processing capability in the node to process the raw data stream. Further, the central controller 104 can be configured to frequently monitor the parameters associated with the node 106 in the M2M network 108 to determine any changes in the parameters associated with the node 106 in the M2M network 108.

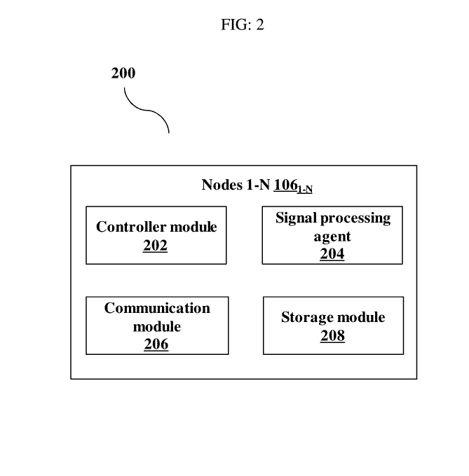

FIG. 2 expands features and functions of the node 106 as described in the FIG. 1, according to embodiments described herein. Each node 106 can be configured to include a controller module 202, a signal processing agent 204, a communication module 206, and a storage module 208.

In an embodiment, the controller module 202 can be configured to identify the raw data stream generated at the node 106.T the controller module 202 can be configured to automatically download and install the signal processing agent received from the central controller 104 to process the raw data streams at the node end itself. Unlike conventional systems, instead of transporting and processing the raw data steams at the back-end processing server, the proposed system and method can be used to process the raw data stream at the node end itself. In an embodiment, the signal processing agent 204 can be configured to process the raw data stream associated with the node 106 by using the signal processing agent which is downloaded and installed by the controller module 202 from the central controller 104. Further, the controller module 202 can be configured to determine whether there is any update/upgrade in the signal processing agents which are earlier received from the central controller 104. The signal processing agent 204 can be configured to receive any updated/upgraded in the signal processing agents from the central controller 104.

In an embodiment, the communication module 206 can be configured to send the parameters associated with the node 106 to the central controller 104. The communication module 206 can be configured to receive the signal processing agents from the central controller 104. Whenever, if there is the change in the raw data stream associated with the node 106, then a new signal processing agent can be generated at the central controller 104 and can be transported to the node 106 to process the raw data stream.

In an embodiment, the storage module 208 can be configured to store various raw data streams associated with the node 106, signal processing agents received from the central controller 104, and the like. The storage module 208 can be configured to store control instructions to perform various operation in the system 100.

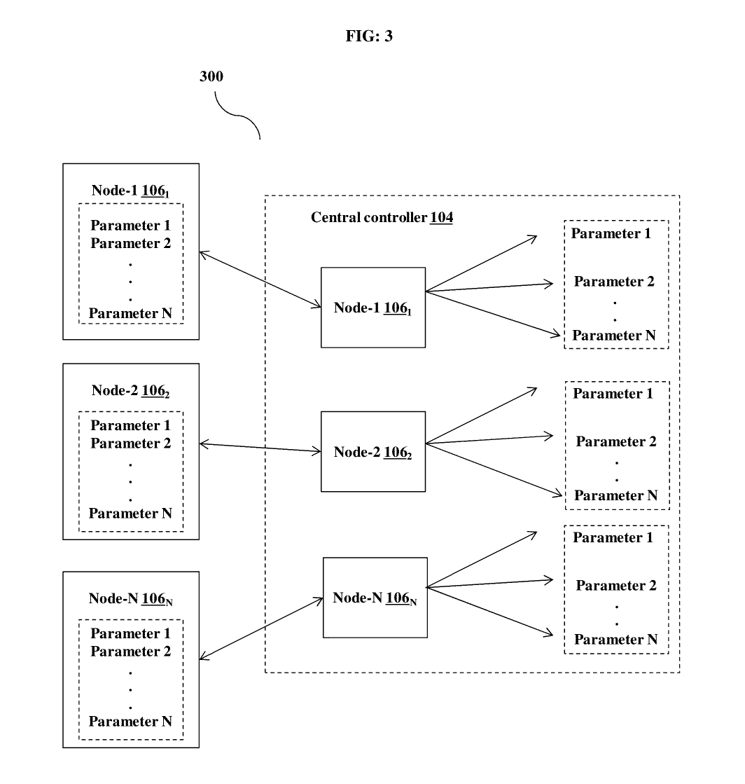

FIG. 3 illustrates functions of a central controller as described in the FIG. 1, according to embodiments as disclosed herein. As depicted in the FIG. 3, the central controller 104 can be communicated with the plurality of nodes 106 over the M2M network 108. The central controller 104 can be configured to continuously monitor and receive the parameters (1-N) associated with each node 106 throughout the network 108.

Each node 106 in the M2M network 108 can be associated with a number of corresponding parameters (1-N) that can be tuned to affect the performance and responsiveness of the system 100, such as shown in the FIG. 3. In an example, the parameters described herein can include for example, but not limited to a, node availability, node characteristics, services offered, near-by nodes, communication link/channel, profile data, user preferences (such as historic data), usage, range, speed, bandwidth, workload, congestion, and the like.

Further, in an embodiment, the node parameters described herein can include for example, but not limited to a, battery level, communication link/channel information (further including the channel quality derived from derived Signal-to-Noise Ratio (SNR)), different types of communication links used by the nodes (for example, Bluetooth, Zig-Bee, Wi-Fi, P2P, ultra wideband, and the like), routing information, cost, device mobility, and the like. In an example, the profile parameter described herein can include for example, but not limited to, a mode in which the node 106 is running such as power saving mode, idle mode, sleep mode, and the like. The link quality information can include signal strength of the node 106. The link quality information can be used by the central controller 104 to determine whether the node 106 in the M2M network 108 has enough capability to process the raw data stream associated with the node 106.

Further, the central controller 104 can be configured to include one or more rules to analyze the parameters to determine the capability of each node 106 in the M2M network 108. Based on the capability of each node, the central controller 104 can be further configured to decide whether to process the raw data stream at the node itself. Unlike conventional systems, instead of transporting and processing the raw data steams at the back-end processing server, the proposed system and method can be used to process the raw data stream at the node end itself. A better end-to-end utilization of the M2M network resources and cost can be achieved as the signal processing is moved down to the node edge where the raw data streams is originating from, given there is enough processing capability in the node to process the raw data stream. The offloading of the signal processing operations from the back-end processing server down through the M2M network to the nodes endpoint compress down the amount of data points being transported up the links from the nodes to the back-end processing server, which significantly decreases the overall system cost.

In an embodiment, the rules described herein can include elements indicating the user preferences and needs. In an example, the elements described herein can include for example, but not limited to a, node battery level, communication link/channel, profile, service quality requirement data, range, speed, bandwidth, security data, workload, congestion, or any other elements.

For example, if the user sends a request for the signal processing agent in the back-end processing server 102 to process the raw data stream generated at the node 106, then the central controller 104 can receive one or more parameters associated with the node 106 in the M2M network 108 to determine the capability of each node 106 in the M2M network 108 by using one or more rules to analyze the parameters; thereby, determining the capability of the node 106. The parameters associated with the node 106 may include for example and not limited to a, battery level, link efficiency, etc.

In an embodiment, the central controller 104 can be configured to analyze the parameters associated with each node 106 to determine the capability of each node 106 in the M2M network 108 by assigning a value (on scale of 1 to 10) to each parameter associated with the node 106 based on the rules. For example, the battery power consumption and link efficiency of the nodes 106 can be determined by the central controller 104 based on the rules. The rules include one or more elements indicating the user requirements and preferences. For example, if a node battery level is greater than 20% then the central controller 104 is configured to assign a priority value 6 else 2. In an embodiment, the rules can be configured by either a network administrator or a user based on the requirements and needs.

Further, the central controller 104 can be configured to frequently monitor each node 106 for detecting any change in the parameters associated with each node 106 in the network 108 to provide seamless, optimal, personalized, reliable, uninterrupted, and enhanced services to the user.

In an embodiment, the central controller 104 can be configured to enter into the sleep mode for certain time intervals, may be when it is running on low battery level, or when the idle time of the central controller 104 passes a standard idle time period. The sleep time interval of the central controller 104 can be configured according to the requirements of the user or an administrator. Once the central controller 104 comes out of sleep mode, the process of monitoring and determining the capability of the nodes 106 can be initiated based on the parameters associated with the nodes 106 in the network 108.

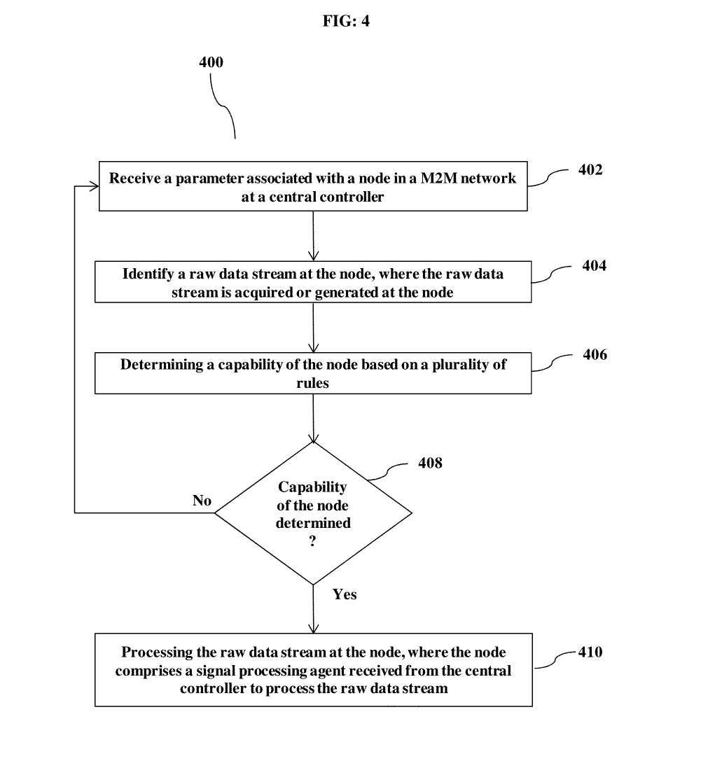

FIG. 4 is a flowchart illustrating a method 400 for automatically offloading a signal processing operation from a back-end processing server down through the M2M network to the nodes endpoint, according to embodiments described herein. At step 402, the method 400 includes receiving a parameter associated with a node 106 in a M2M network 108. In an embodiment, the node 106 can be, for example and not limited to a device or a sensor. In an embodiment, the parameter can be, for example and not limited to a, node availability, node characteristics, services offered by the node, service availability, service characteristics, service quality, processing power, battery condition, communication channel quality, profile data, user preferences, usage data, range, speed, bandwidth, cost, workload, security data, and congestion. The method 400 allows a central controller 104 to receive the parameters associated with the node 106 in the M2M network 108. At step 404, the method 400 includes identifying the raw data stream. The raw data stream is acquired or generated at the node 106. The method 400 allows the controller module 202 to identify the raw data stream associated with the node 106.

At step 406, the method 400 includes determining the capability of the node 106 based on the plurality of rules. The method 400 allows the central controller 104 to include one or more rules to analyze the parameters to determine the capability of each node 106 in the M2M network 108. Based on the capability of each node 106, the central controller 104 can be configured to decide whether to process raw data stream at the node itself or not as shown in the step 408. At step 410, the method 400 includes processing the raw data stream at the node 106 with the signal processing agent received from the central controller 104 based on the capability of the node 106 decided by the central controller 104 at step 408. The method 400 allows the signal processing agent 204 in the node 106 to process the raw data stream by using the signal processing operations received from the central controller 104. Unlike the conventional systems, the raw data stream generated in the node can be processed at the node itself by receiving the signal processing operations from the central controller; thereby, providing better end-to-end utilization of M2M network resources and cost, because signal processing at the node can compress down the amount of data points being transported up the links from the nodes to the back-end processing server.

The various steps, acts, blocks, units, and actions of the method 400 may be performed in the order presented, in a different order or simultaneously. Further, in some embodiments, some steps, acts, blocks, units, and actions listed in the FIG. 4 may be omitted, added, or skipped without departing from the scope of the embodiment.

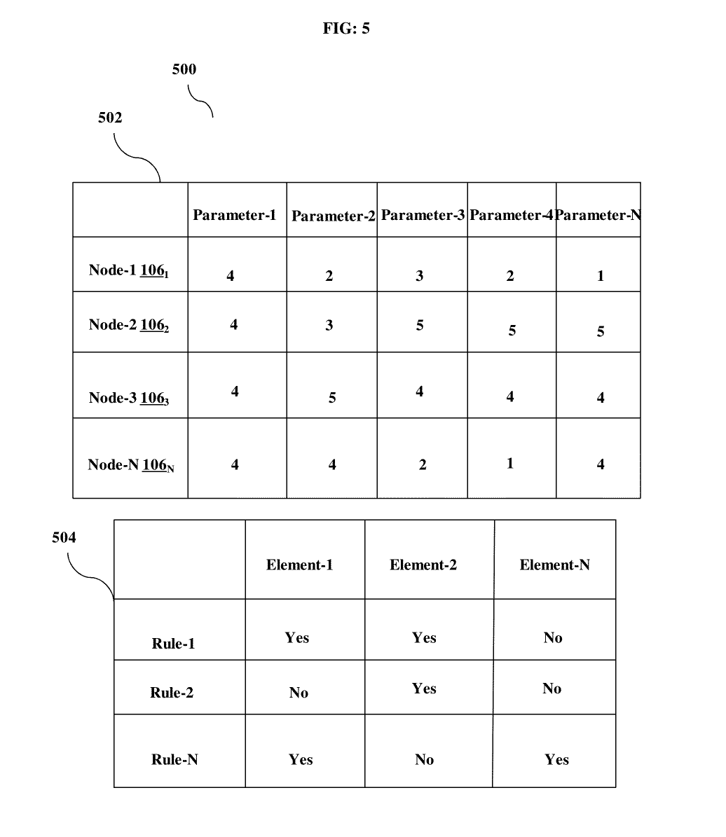

FIG. 5 illustrates exemplary rules for determining the capability of a node to process a raw data stream, according to embodiments as disclosed herein. Each parameter of the node 106 can be received and analyzed by the central controller 104 based on the rules to determine the capability of the node 106 to process the raw data stream. As shown in the FIG. 5, an exemplary parameters and assigned values (on scale of 1 to 5) are described in table 502. Further, a set of predefined rules for analyzing the received parameters based on the battery level, node characteristics, and link quality information is described in table 504. As shown in the FIG. 5, the rule 1-N includes element-1, element-2, and element-N respectively. Each rule can include same (or substantially similar), and/or different set of elements.

These elements represent the requirements and needs of the user over the parameters (such as the node availability, node characteristics, communication links/channel quality, user preferences, usage, range, speed, bandwidth, workload, congestion, security, power consumption, and the like) of the nodes 106. For example, the rule-1 states that if the battery level parameter of the node 106₁ is 60% and the element-1 of the rule indicates the desired need of the user is true (such as if the desired need of the user is to select a node which includes battery level greater than 50%) then the central controller 104 is configured to provide the value of 4. Similarly, if the central controller 104 determines that all other nodes within the network 108 includes the battery level greater than 50% then the value of 4 can be assigned to the battery level parameter of all other nodes such as shown in the table 502.

Similarly, the central controller 104 obtains the communication link parameter associated with the nodes 106. If the central controller 104 determines that the user requirement is to process the raw data stream associated with the node 106 then the central controller 104 can assign a priority value as 5 to the nodes which has the capability to process the electric data (such as the device 106₃). Similarly, the central controller 104 can determine the link quality parameter associated with the nodes 106. If rule elements indicate that the user desired node should include a Signal-to-Noise Ratio (SNR) level greater than 10 then the central controller 104 can assign the priority value as 5 to the nodes 106 whose SNR is greater than 10.

Further, the central controller 104 can ensure that the parameters associated with nodes 106 are analyzed in order of appropriateness and requirements of the user based on the one or more rules. The central controller 104 can be configured to include various combinations of elements, such as to provide values to each parameter of the node 106. Further, the various elements described herein can include for example, such as user preferences, user history, network administrator preferences, node profile, controller profile, node battery level, controller battery level, node status (active/sleep/idle), controller status (active/sleep/idle), communication channels, and the like.

In an embodiment, the central controller 104 can be configured to combine the values of all the parameters associated with each node in the network 108. The central controller 104 can calculate a sum of all the values of the parameters associated with each node 106. For example, a sum of all the values of the parameters associated with node 106₁ may include, for example, 4+2+3+2+1=11. Similarly, for the node 106₂, a sum of all the values may include, for example, 4+3+5+5+5=22, and so on. Furthermore, the central controller 104 can be configured to determine the capability of the nodes 106 by comparing the sum to a predefined threshold value. The predefined threshold can be a decision matrix (such as a value or threshold limits) for determining the capability of the node 106 for processing the raw data stream associated with the node 106. In an embodiment, the threshold value can be predefined by a network administrator or evaluated by the central controller 104 based on one or more rules. If the combined sum of values of all the parameters associated with the node reaches the priority threshold then the central controller 104 can be configured to determine that the node has the capability to process the raw data stream acquired or generated at the node 106. For example, if the threshold value as defined by the central controller 104 is 17 and the combined value (the sum value) associated with the nodes 1-5 are 14, 15, 16, 13 and 17 respectively then the central controller 104 detects the node-5 (with the combined value as 17) as the node which is capable of processing the raw data stream, while determining that the other nodes are not capable of processing the raw data stream.

Further, if the combined values of all the nodes lie within the threshold value then the central controller 104 can determine the node whose combined value is closer to the pre-defined threshold value.

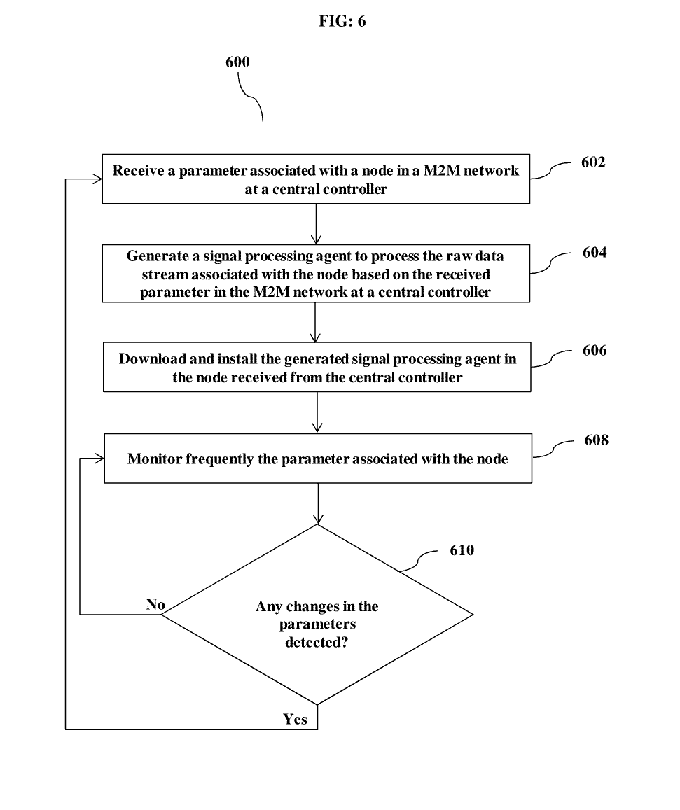

FIG. 6 is a flowchart illustrating a method 600 for managing and updating the signal processing agents at each node in the M2M network, according to embodiments disclosed herein. At step 602, the method 600 includes receiving a parameter associated with a node 106 in the M2M network 108. In an embodiment, the node 106 can be, for example and not limited to a device or a sensor. In an embodiment, the parameter can be, for example and not limited to a, node availability, node characteristics, services offered by the node, service availability, service characteristics, service quality, processing power, battery condition, communication channel quality, profile data, user preferences, usage data, range, speed, bandwidth, cost, workload, security data, and congestion. The method 600 allows a central controller 104 to receive the information about one or more parameters associated with each node 106 in the M2M network 108. At step 604, the method 600 includes generating a signal processing agent to process the raw data stream of the node 106 based on the capability of the node 106 determined by the central controller 104. The method 600 allows the central controller 104 to generate the signal processing agent to process the raw data stream of the node 106 based on the capability of the node 106.

At step 606, the method 600 includes downloading and installing the signal processing agent to process the raw data streams at the node end itself in the network 108. The method 600 allows the controller module 202 to download and install the signal processing agent received from the central controller 104 to process the raw data streams at the node end itself in the network 108. At step 608, the method 600 includes monitoring frequently the parameters associated with the node 106 in the network 108. The method 600 allows the central controller 104 to monitor frequently the parameters associated with the node 106 in the M2M network 108. At step 610, the method 600 includes receiving the changed parameters associated with the node 106 in the network 108; else, monitor frequently the parameters associated with the node 106 until the change in the parameters is detected.

The various steps, acts, blocks, units, and actions of the method 600 may be performed in the order presented, in a different order or simultaneously. Further, in some embodiments, some steps, acts, blocks, units, and actions listed in the FIG. 6 may be omitted, added, or skipped without departing from the scope of the embodiment.

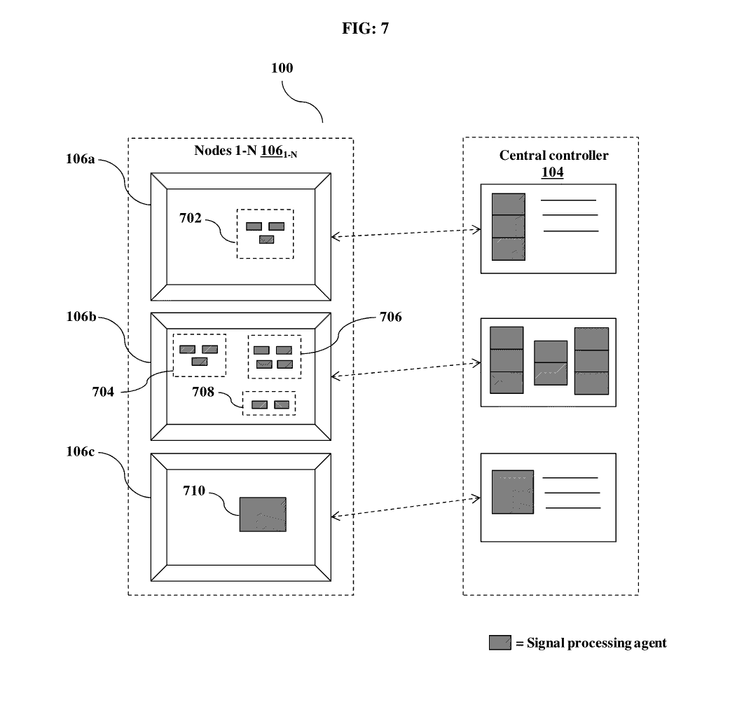

FIG. 7 illustration an example scenario of managing and updating the signal processing agents at each node in the M2M network, according to embodiments described herein. In an embodiment, the central controller 104 can be configured to collect the information about one or more parameters associated with each node 106 in the M2M network 108. The central controller 104 can be configured to use network analysis tools to analyze the collected information about one or more parameters for determining the capability of the node 106 to provide appropriate signal processing agent to process the raw data stream generated at the node 106 in the M2M network 104.

As shown in the FIG. 7, each node 106 in the network 108 can include different versions of the same signal processing agent providing different services, features, functions, and benefits to the user. Each node can be used to evaluate and synchronize signal processing agents and automatically download, install, and update/upgrade signal processing agents to process the raw data stream of the node in the M2M network. For example, the node 106a includes three different versions of same signal processing agent as shown at 702. Each version may be used by the node 106 in different ways to access services available in the network 108. Similarly, the node 106b includes three versions of the signal processing agent as shown at 704, four versions of another signal processing agent as shown at 706, and two versions of yet another signal processing agent as shown at 708. In another example, the node 106c includes only one version of the signal processing agent as shown at 710.

In an embodiment, the central controller 104 can be configured to receive information about the signal processing agents associated with each node 106 in the network 108. An appropriate version of the signal processing agents can be evaluated and synchronized based on the received information. The central controller 104 can be configured to use the network analysis tools to determine appropriate, compatible, and synchronized versions (and/or updates) for the signal processing agents. Error-free, fast, synchronous, and inexpensive updates/upgrades can be performed for each node through the M2M networks from the central controller 104.

The central controller 104 can be configured to include total control over the signal processing agents and associated operations performed on the nodes 106. Further, the central controller 104 can be configured to manage and maintain the configuration of the signal processing agents, links associated among the nodes 106, the nodes 106 status information, parameters associated with the node 106 to determine the capability of the node 106, services offered by each version of signal processing agent, services used by each node 106, and the like to evaluate and synchronize appropriate signal processing agents for each node 106 in the network 108. The central controller 104 can be further configured to continuously monitor signal processing agents to provide associated updates (and/or upgrades) and optimize the M2M network 108, such as to increase the network performance, availability of resources, and decrease the network maintenance cost.

Furthermore, the exemplary values and rules described herein are only for illustrative purpose and do not limit the scope of the embodiment. In real-time the values may be given using weighing factor, rank ordering methods, stars, ratings, and the like. Furthermore, the rules can be implemented/performed in any order/form and other elements, components, steps, and operations, may be added, skipped, deleted, and modified without departing from the scope of the embodiment.

The embodiments disclosed herein can be implemented through at least one software program running on at least one hardware device and performing network management functions to control the network elements. The elements shown in the FIGS. 1 through 7 include blocks which can be at least one of a hardware device, or a combination of hardware device and software module.

The embodiment disclosed herein specifies a system for automatically offloading the signal processing operation from the back-end processing server in the M2M network applications. The mechanism allows identifying the raw data stream in the node and processing the raw data stream at the node. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for automatically offloading at least one signal processing operation from a back-end processing server in a Machine-to-Machine (M2M) network comprising a plurality of nodes controlled using a central controller, the method comprising:
identifying at least one raw data stream in at least one said node, wherein said at least one raw data stream is acquired using at least one said node; and
processing said at least one raw data stream at at least one said node, wherein each said node comprises at least one signal processing agent received from said central controller to process said at least one raw data stream.

2. The method of claim 1, wherein processing said at least one raw data stream at at least one said node comprises:
receiving, at said central controller, at least one parameter associated with each said node in said M2M network;
identifying, at said central controller, a capability of each said node based on a plurality of rules; and
processing at least one raw data stream at corresponding said node based on said identified capability, wherein each said node comprises at least one signal processing agent received from said central controller to process said at least one raw data stream.

3. The method of claim 2, wherein said at least one parameter comprises at least one of said node availability, said node characteristics, services offered by said node, said service availability, said service characteristics, said service quality, processing power, battery condition, communication channel quality, profile data, user preferences, usage data, range, speed, bandwidth, cost, workload, security data, and congestion.

4. The method of claim 1, wherein each said node is configured to automatically download and install said at least one agent to process said at least one raw data stream.

5. A method for automatically offloading at least one signal processing operation from a back-end processing server in a Machine-to-Machine (M2M) network comprising a plurality of nodes controlled using a central controller, the method comprising:
receiving, at said central controller, at least one parameter associated with each said node in said M2M network;
identifying, at said central controller, a capability of each said node based on a plurality of rules; and
processing at least one raw data stream at corresponding said node based on said identified capability, wherein each said node comprises at least one signal processing agent received from said central controller to process said at least one raw data stream.

6. The method of claim 5, wherein said at least one parameter comprises at least one of said node availability, said node characteristics, services offered by said node, said service availability, said service characteristics, said service quality, processing power, battery condition, communication channel quality, profile data, user preferences, usage data, range, speed, bandwidth, cost, workload, security data, and congestion.

7. The method of claim 5, wherein each said node is configured to automatically download and install said at least one agent to process said at least one raw data stream.

8. A system for automatically offloading at least one signal processing operation from a back-end processing server in a Machine-to-Machine (M2M) network comprising a plurality of nodes controlled using a central controller, wherein at least one said node is configured to:
identify at least one raw data stream acquired at said at least one node; and
process said at least one raw data stream, wherein each said node comprises at least one signal processing agent received from said central controller to process said at least one raw data stream.

9. The system of claim 8, wherein process said at least one raw data stream at at least one said node comprises:
receive, at said central controller, at least one parameter associated with each said node in said M2M network;
identify, at said central controller, a capability of each said node based on a plurality of rules; and
process at least one raw data stream at corresponding said node based on said identified capability, wherein each said node comprises at least one signal processing agent received from said central controller to process said at least one raw data stream.

10. The system of claim 9, wherein said at least one parameter comprises at least one of said node availability, said node characteristics, services offered by said node, said service availability, said service characteristics, said service quality, processing power, battery condition, communication channel quality, profile data, user preferences, usage data, range, speed, bandwidth, cost, workload, security data, and congestion.

11. The system of claim 8, wherein each said node is configured to automatically download and install said at least one agent to process said at least one raw data stream.

12. A system for offloading at least one signal processing operation from a back-end processing server in a Machine-to-Machine (M2M) network comprising a plurality of nodes controlled using a central controller, wherein said central controller is configured to:
receive at least one parameter associated with each said node in said M2M network;
identify a capability of each said node based on a plurality of rules; and
process at least one raw data stream at corresponding said node based on said identified capability, wherein each said node comprises at least one signal processing agent received from said central controller to process said at least one raw data stream.

13. The system of claim 12, wherein said at least one parameter comprises at least one of said node availability, said node characteristics, services offered by said node, said service availability, said service characteristics, said service quality, processing power, battery condition, communication channel quality, profile data, user preferences, usage data, range, speed, bandwidth, cost, workload, security data, and congestion.

14. The system of claim 12, wherein each said node is configured to automatically download and install said at least one agent to process said at least one raw data stream.

15. A computer program product comprising computer executable program code recorded on a computer readable non-transitory storage medium for automatically offloading at least one signal processing operation from a back-end processing server in a Machine-to-Machine (M2M) network comprising a plurality of nodes controlled using a central controller, said computer executable program code when executed, causing the actions including:
identifying at least one raw data stream in at least one said node, wherein said at least one raw data stream is acquired using at least one said node; and
processing said at least one raw data stream at at least one said node, wherein each said node comprises at least one signal processing agent received from said central controller to process said at least one raw data stream.

16. The computer program product of claim 15, wherein processing said at least one raw data stream at at least one said node comprises:
receiving, at said central controller, at least one parameter associated with each said node in said M2M network;
identifying, at said central controller, a capability of each said node based on a plurality of rules; and
processing at least one raw data stream at corresponding said node based on said identified capability, wherein each said node comprises at least one signal processing agent received from said central controller to process said at least one raw data stream.

17. The computer program product of claim 16, wherein said at least one parameter comprises at least one of said node availability, said node characteristics, services offered by said node, said service availability, said service characteristics, said service quality, processing power, battery condition, communication channel quality, profile data, user preferences, usage data, range, speed, bandwidth, cost, workload, security data, and congestion.

18. The computer program product of claim 15, wherein each said node is configured to automatically download and install said at least one agent to process said at least one raw data stream.

19. A computer program product comprising computer executable program code recorded on a computer readable non-transitory storage medium for automatically offloading at least one signal processing operation from a back-end processing server in a Machine-to-Machine (M2M) network comprising a plurality of nodes controlled using a central controller, said computer executable program code when executed, causing the actions including:
receiving, at said central controller, at least one parameter associated with each said node in said M2M network;
identifying, at said central controller, a capability of each said node based on a plurality of rules; and
processing at least one raw data stream at corresponding said node based on said identified capability, wherein each said node comprises at least one signal processing agent received from said central controller to process said at least one raw data stream.

20. The computer program product of claim 19, wherein said at least one parameter comprises at least one of said node availability, said node characteristics, services offered by said node, said service availability, said service characteristics, said service quality, processing power, battery condition, communication channel quality, profile data, user preferences, usage data, range, speed, bandwidth, cost, workload, security data, and congestion.

21. The computer program product of claim 19, wherein each said node is configured to automatically download and install said at least one agent to process said at least one raw data stream.
